(19) United States
(12) Patent Application Publication
(10) Pub. No.: US 2010/0220141 A1
(43) Pub. Date: Sep. 2, 2010

(54) INK-JET PRINTER

(75) Inventor: Chizuo Ozawa, Nagano (JP)

Correspondence Address: BUCHANAN, INGERSOLL & ROONEY PC, POST OFFICE BOX 1404, ALEXANDRIA, VA, 22313-1404, US

(73) Assignee: MASTERMIND CO., LTD., Shiojiri-shi (JP)

(21) Appl. No.: 12/600,040

(22) PCT Filed: May 9, 2008
(86) PCT No.: PCT/JP2008/001175

§ 371 Date: Nov. 13, 2009

(30) Foreign Application Priority Data
May 14, 2007 (JP) 2007-128093

(51) Int. Cl. B41J 29/377

(52) U.S. Cl. 347/18

(57) ABSTRACT

A head carriage of an ink-jet printer is equipped with a heat lamp unit. The heat lamp unit is located very close to ink droplets discharged from an ink-jet head and landing on a recording medium and can directly heat and cure the ink droplets, so that the ink droplets can be efficiently fixed. If the heat lamp unit is placed very close to the ink-jet head, clogging of a nozzle of the ink-jet head and thermal failure of the ink-jet head itself may be caused by heat release of the heat lamp unit, but the heat lamp unit can be cooled efficiently by a cooling mechanism which circulates a refrigerant through a refrigerant circulating pipe by a refrigerant circulating pump, so that the ink-jet head can be prevented from being heated.

### TECHNICAL FIELD

The present invention relates to an inkjet printer suitable for printing on the surface of paper, cloth, film, glass plates, metal plates, resin plates, wood plates, and various other recording media.

### BACKGROUND ART

An inkjet printer capable of printing various recording media having varying thicknesses and sizes using an inkjet printer has been proposed. In Patent Document 1, the present inventor has proposed a large inkjet-type printer for printing on the surface of wooden plate material, round material, or any other thick recording medium. This large printer is configured so as to perform printing by conveying a media conveyance tray that holds a recording medium through a print position of a print head. The configuration also makes it possible to adjust the gap between the print head and the recording medium by elevating the conveyance mechanism of the media conveyance tray.

[Patent Document 1] Japanese Laid-open Patent Application No. 2000-190467

With an inkjet-type printer, ink droplets discharged from the inkjet head land on the surface of a recording medium, and are then absorbed, cured, and fixed to the surface. The surface of the recording medium can be heated in order to fix the deposited ink droplets with good efficiency. It is particularly effective to use heat in the case that printing is carried out on a recording medium composed of a material not readily amenable for the fixing of a water-based ink, a solvent ink, or the like. Heating is required in the case that a resin ink or another thermosetting ink is used for printing because the ink droplets deposited on the recording medium must be heated and cured.

In common heating methods, a platen that defines a print position of the inkjet head is heated and the portion of the recording medium on which the ink droplets are deposited is heated. Although this heating method is effective for paper and other thin recording media, the method is not effective for thick recording media because extra time is required to heat the recording medium to a temperature suitable for curing the ink.

The inkjet head is arranged in a state facing the platen across a small gap and prints while moving along the platen. Therefore, with this method of heating the platen, the inkjet head facing the platen is also heated, and the ink inside the ink nozzles increases in viscosity, coagulates, and causes ink clogging. In some cases, the inkjet head may suffer heat damage.

It is furthermore difficult to uniformly heat a portion of the recording medium that passes over that platen. Accordingly, the print quality may be nonuniform and may degrade.

Additionally, Nichrome wires or the like are conventionally used as heating means, so there is a drawback in that conventional heating means must be constantly energized, power consumption is high, and running costs are high.

### DISCLOSURE OF THE INVENTION

The present invention was contrived in view of the foregoing, and an object thereof is to provide an inkjet printer that can print with good fixing characteristics on glass plates, metal plates, resin plates, wood plates, and various other recording media.

In order to achieve the objects described above, the inkjet printer of the present invention is characterized in comprising:

an inkjet head;

a platen for defining a print position for the inkjet head;

a heater for heating ink droplets discharged from the inkjet head and deposited on a recording medium on the platen;

a head carriage that supports the inkjet head and the heater; and

a cooling mechanism for cooling the external peripheral surface portion excluding the heat-radiating aperture in the heater, the cooling mechanism having:

a refrigerant circulating pipe disposed in a state of contact with the constituent elements of the heater inside and/or outside the heater;

a refrigerant circulating pump disposed in a fixed position that does not interfere with the head carriage;

a flexible refrigerant circulating tube for placing the refrigerant circulating pipe and the refrigerant circulating pump in communication with each other; and

a cooling device for cooling the refrigerant that flows through the refrigerant circulating tube.

In the inkjet printer of the present invention, a heater is mounted on the head carriage and moves together with the inkjet head. The heater is positioned very close to the ink droplets that have been discharged from the inkjet head and deposited on the recording medium, and can directly heat and cure the ink droplets. Accordingly, the ink droplets can be fixed on the recording medium with good efficiency.

In the case that the heater is arranged very close to the inkjet head, the nozzles of the inkjet head are liable to clog due to heat dissipation from the heater, and the inkjet head itself may incur heat damage. However, in the present invention, the inkjet head can be prevented from heating, or the amount of heating can be reduced by cooling the heater with a cooling mechanism.

The heater is typically provided with a cylindrical casing in which one of the open ends is an aperture for radiating heat. In this case, the refrigerant circulating pipe is disposed in contact with the external peripheral surface and/or the internal peripheral surface of the casing. For example, the refrigerant circulating pipe is arranged in a helical shape along the external peripheral surface and/or the internal peripheral surface of the casing.

Next, the present invention is characterized in that an insulating material is arranged along the internal peripheral surface of the casing, and the refrigerant circulating pipe is arranged between the internal peripheral surface and the insulating material. Accordingly, heat can be suppressed or prevented from dissipating to the periphery by providing the heater with insulation and heat dissipation countermeasures. Accordingly, an adjacently disposed inkjet head can be reliably prevented from heating up.

A halogen lamp or another discharge lamp may be used as the heater. In such a case, the heater may have a configuration that includes a halogen lamp or another discharge lamp, a reflecting mirror for reflecting light emitted from the discharge lamp toward the heat-radiating aperture, and a cylindrical lens-barrel that coaxially extends from the emission aperture of the reflecting mirror in the emission direction.

In this case, the refrigerant circulating pipe is disposed in a state of contact with the external peripheral surface and/or the internal peripheral surface of the lens-barrel. The refrigerant circulating pipe may be disposed in a state of contact with the external peripheral surface of the reflecting mirror. In these cases, the refrigerant circulating pipe may be arranged in a helical shape.

Insulating material may be arranged along the internal peripheral surface of the lens-barrel, and the refrigerant circulating pipe may be disposed between the internal peripheral surface and the insulating material.

Next, the present invention is characterized in having a refrigerant circulating pipe for cooling the inkjet head and/or the head carriage in addition to the refrigerant circulating pipe for cooling the heater.

The cooling mechanism of the present invention is suitable for use in an inkjet printer provided with an inkjet head for printing using resin ink or another thermosetting ink.

In the inkjet printer of the present invention, a heater is mounted in the head carriage so that the ink droplets discharged from the inkjet head and deposited on the recording medium can be directly heated, and a cooling mechanism is arranged so that the inkjet head is not heated by the adjacently disposed heater. Therefore, in accordance with the present invention, it is possible to prevent nozzle clogging, heat damage to the inkjet head itself, and other problems caused by the heating of the inkjet head. Also, ink droplets can be heated and cured and fixed to the recording medium with good efficiency.

### BRIEF DESCRIPTION OF THE DRAWINGS

FIG. 1 is a schematic perspective view of an inkjet printer to which the present invention has been applied;

FIG. 2 is a schematic block diagram of the inkjet printer of FIG. 1;

FIG. 3 is a schematic perspective view and schematic cross-sectional view showing the heater and the cooling mechanism of FIG. 1;

FIG. 4 is a descriptive view showing an example of the arrangement of the refrigerant circulating pipe;

FIG. 5 is a descriptive view showing the heater provided with insulating material; and

FIG. 6 is a descriptive view showing an example of the cooling mechanism of an inkjet head.

### BEST MODE FOR CARRYING OUT THE INVENTION

An inkjet printer in which the present invention has been applied is described below with reference to the drawings.

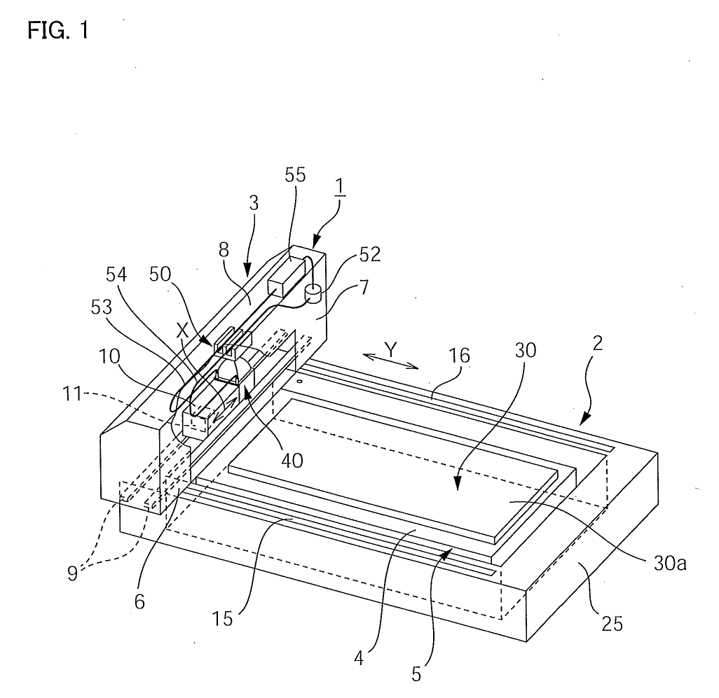

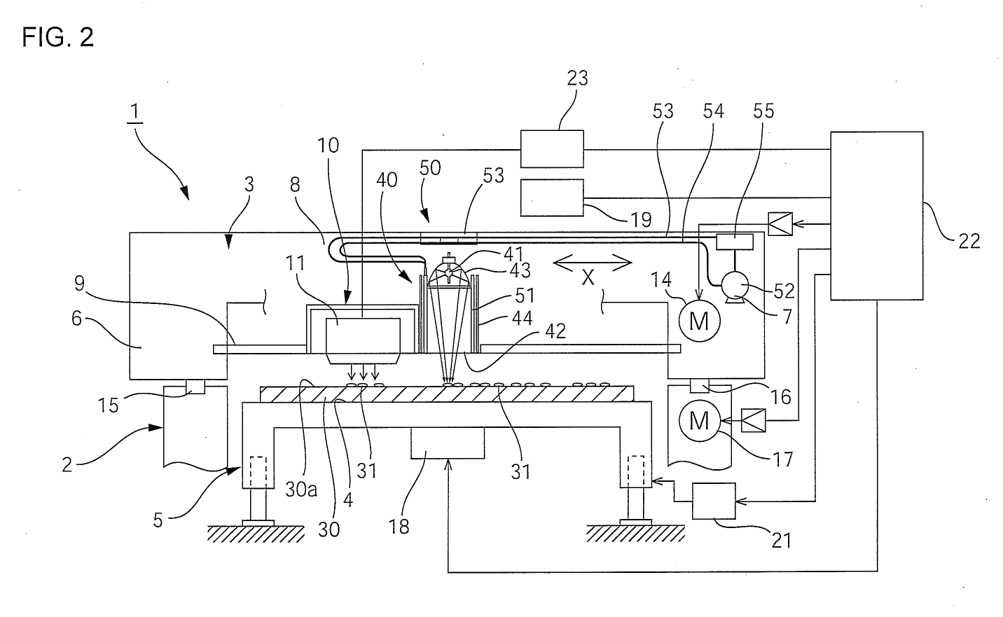

FIG. 1 is a schematic perspective view of an inkjet printer of the present example. FIG. 2 is a schematic block diagram additionally showing the control system of the inkjet printer. The inkjet printer 1 of the present example has a platform 2 in the form of an oblong rectangular frame, a portal-type support unit 3 mounted on the platform 2, and a table 5 (platen) provided with a horizontal rectangular media-mounting surface 4 disposed within the platform 2.

The support unit 3 is provided with left and right vertical frames 6, 7, and a horizontal frame 8 that bridges the vertical frames. The horizontal frame 8 is provided with a carriage guide 9 that horizontally bridges the left and right vertical frames 6, 7, and a head carriage 10 that can move along the carriage guide 9 in reciprocating fashion in the width direction of the printer. An inkjet head 11 is supported facing downward on the head carriage 10. The head carriage 10 is moved in a reciprocating fashion in the width direction X of the printer by a carriage drive mechanism that includes a carriage motor 14.

A heat lamp unit 40 (heater) provided with a halogen lamp 41 is mounted on a side surface, as viewed in the movement direction, of the head carriage 10. Light emitted by the heat lamp unit 40 is directed downward from the heat-radiating aperture 42. A heat lamp other than a halogen lamp may also be used. Heating means other than a heat lamp may also be used. A heat lamp unit may be mounted on the two sides of the head carriage 10.

A resin ink is fed from an ink tank (not shown) to the inkjet head 11, and printing is carried out using the resin ink on a print surface 30a of a recording medium 30 mounted on the media-mounting surface 4. A thermosetting ink other than a resin ink may also be used.

Next, the support unit 3 on which the head carriage 10 and the like are mounted is supported in a state that allows movement in the forward/rearward direction Y of the printer along left and right guide frames 15, 16 of the platform 2. The support unit 3 is moved in the forward-rearward direction Y of the printer by a feed mechanism that includes a feed motor 17.

The table 5 is provided with a heating mechanism 18 for heating the media-mounting surface 4. The recording medium 30 mounted on the media-mounting surface 4 is heated from the reverse side by the heating mechanism 18. The area in which the ink droplets are deposited is spot heated from above by the heat lamp unit 40 which moves together with the head carriage 10. In the present example, a temperature control function is incorporated into the heating mechanism 18, drive current is fed to the heat lamp unit 40 via a voltage control circuit 19, and the heating temperature can be controlled.

The table 5 may, e.g., be a hydraulic elevator-type table, and is capable of adjusting the height using a hydraulic drive mechanism 21. Each part is controlled, by a printer control panel 22 configured around a microcomputer or the like.

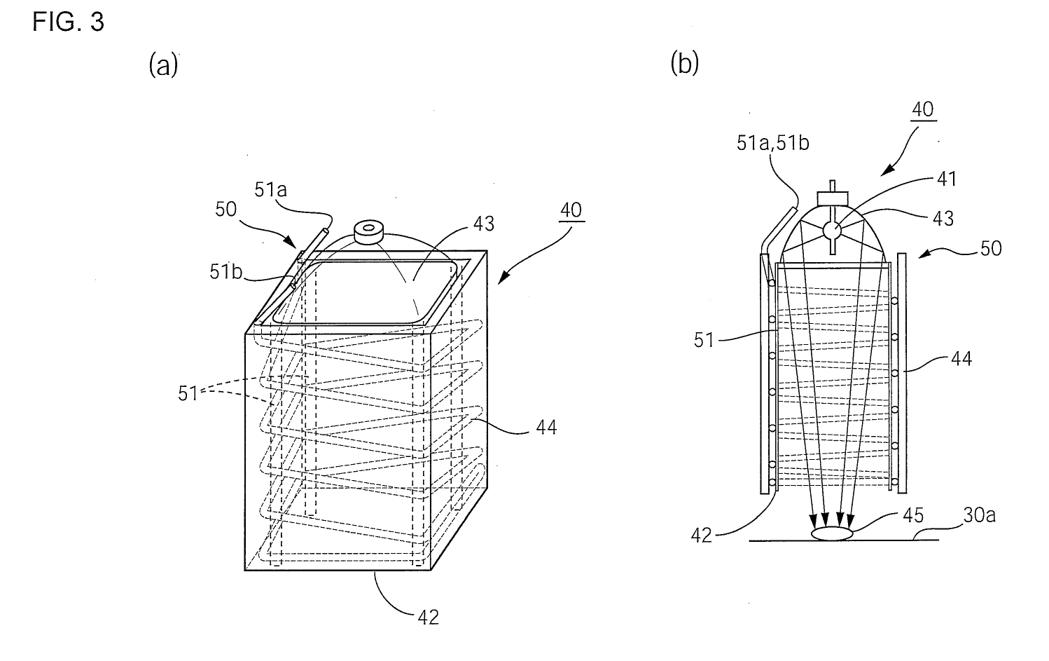

FIG. 3 is a schematic perspective view and schematic cross-sectional view showing the heat lamp unit 40 mounted on the head carriage 10. The heat lamp unit 40 has a halogen lamp 41, a reflecting mirror 43 on which the halogen lamp 41 is mounted, and a lens-barrel 44 that is rectangular in cross section and is coaxially mounted on the emission aperture part of the reflecting mirror 43. The lower end aperture of the lens-barrel 44 is the heat-radiating aperture 42. The lens-barrel 44 may be a shape other than one with a rectangular cross section, e.g., one with a cylindrical shape. The light emitted from the light-emitting part of the halogen lamp 41 reflects from the reflecting mirror 43, forms a light spot 45 having a predetermined diameter on the print surface 30a of the recording medium 30 on the media-mounting surface 4, and heats the area of the light spot on the print surface 30a.

A cooling mechanism 50 is mounted on the heat lamp unit 40 having the structure described above. As shown in FIGS. 1, 2, and 3, the cooling mechanism 50 is provided with a refrigerant circulating pipe 51 disposed in a state of contact with the constituent elements of the heat lamp unit 40 outside and/or inside the heat lamp unit 40, a refrigerant circulating pump 52 disposed in a fixed position that does not interfere with the head carriage 10, flexible refrigerant circulating tubes 53, 54 for placing the refrigerant circulating pipe 51 and the refrigerant circulating pump 52 in communication with each other, and a cooling device 55 for cooling the refrigerant that flows through the refrigerant circulating tube 53.

The refrigerant circulating pipe 51 is arranged in a state of contact with the internal peripheral surface of the lens-barrel 44 of the heat lamp unit 40 in a helical shape along the internal peripheral surface. It is possible to use a copper tube or the like having good thermal conductivity as the refrigerant circulating pipe 51. The two end portions 51a, 51b of the refrigerant circulating pipe 51 protrude upward from the upper end surface of the lens-barrel 44. The two end portions 51a, 51b are connected to one end of the refrigerant circulating tubes 53, 54, respectively. The other end of the refrigerant circulating tube 53 is connected to the suction port of the refrigerant circulating pump 52 via the cooling device 55, and the other end of the refrigerant circulating tube 54 is connected to the discharge port of the refrigerant circulating pump 52. The refrigerant circulating pump 52 is disposed in a position away in the lateral direction from the movement range of the head carriage 10.

The operation of the inkjet printer 1 of the configuration described above will be described. The recording medium 30 is placed on the media-mounting surface 4 of the table 5, and the gap between the inkjet head 11 and the print surface 30a of the recording medium 30 is adjusted by the hydraulic drive mechanism 21. Prior to or following the gap adjustment, the heating mechanism 18 is driven and the media-mounting surface 4 is heated.

The carriage motor 14 and the feed motor 17 are thereafter driven, the support unit 3 is moved in the forward/rearward direction Y of the printer from the home position shown in the drawing, and the head carriage 10 mounted on the support unit is moved in the width direction X of the printer. In synchronization with the above, the inkjet head 11 is driven via a head driver 23, and desired printing is carried out while the resin ink droplets are discharged onto the print surface 30a of the recording medium 30.

The heat lamp unit 40 is switched on prior to the printing action of the inkjet head 11. Therefore, heat rays are immediately directed on the resin ink droplets 31 discharged from the inkjet head 11 and deposited on the print surface 30a of the recording medium 30, and thermosetting is started. Since the media-mounting surface 4 is also heated in the present example, the print surface 30a of the recording medium 30 may be kept in an optimal heated state suitable for allowing the resin ink to be thermoset. Thus, the resin ink droplets are progressively fixed on the print surface 30a simultaneous to the printing operation. In this manner, printing on the print surface 30a of the recording medium 30 is performed while the printing and thermosetting are carried out at the same time.

The heat lamp unit 40 is cooled by the cooling mechanism 50 disposed in the heat lamp unit. Specifically, the heat generated by the heat lamp unit 40 is released by the refrigerant circulating through the refrigerant circulating pipe 51. When printing has ended, the support unit 3 is again returned to the home position shown in the drawing.

As described above, in the inkjet printer 1 of the present example, printing is carried out on the print surface of the recording medium 30 using resin ink. Therefore, printing can be performed without carrying out a surface treatment in advance with the aim of forming an ink image reception surface on recording media composed of various materials.

Since the thermosetting of resin ink is carried out by the heat lamp unit 40 at the same time as the printing operation, a printed recording medium can be obtained in a state in which the ink is fixed simultaneous to the end of the printing operation. In addition, the media-mounting surface 4 is heated by the heating mechanism 18. Therefore, the resin ink can be thermoset with good efficiency, and the printing operation can accordingly be carried out with good efficiency using a resin ink.

The cooling mechanism 50 is furthermore mounted on the heat lamp unit 40, and the heat generated by the heat lamp unit 40 is released with good efficiency by the cooling mechanism 50. Accordingly, it is possible to prevent an inkjet head 11 disposed in an adjacent position from being heated by the heat from the heat lamp unit 40, and to prevent clogging, heat damage of the inkjet head itself, and other problems.

In addition, the platen gap can be adjusted by raising or lowering the table 5, thereby making it possible to perform printing on recording media of various thicknesses without a reduction in the print quality. Examples of such media range from thin cloth and film to thick resin plates, metal plates, and wood plates.

Next, the platform 2 of the present example is shaped as a rectangular frame, but it is also possible to use a configuration in which the forward frame 25 for bridging the left and right guide frames 15, 16 is removed. In this case, wheels or the like may be mounted on the table 5 disposed between the left and right guide frames 15, 16 to thereby make it possible to bring out the table from the installed position between the left and right guide frames 15, 16. The table can be brought out and a recording medium can placed on the table in a separate location. The table carrying the recording medium can be inserted and positioned between the left and right guide frames 15, 16 to thereby form a state in which the recording medium has been mounted. The operation for replacing the recording medium can thereby be carried out in a simple manner with good efficiency. This is particularly advantageous when printing on a large, heavy recording medium.

The example described above is an example in which the present invention has been applied to a large inkjet printer. The present invention may naturally be applied in a similar fashion to a small printer for printing on paper, film, cloth, or the like.

### Other Embodiments

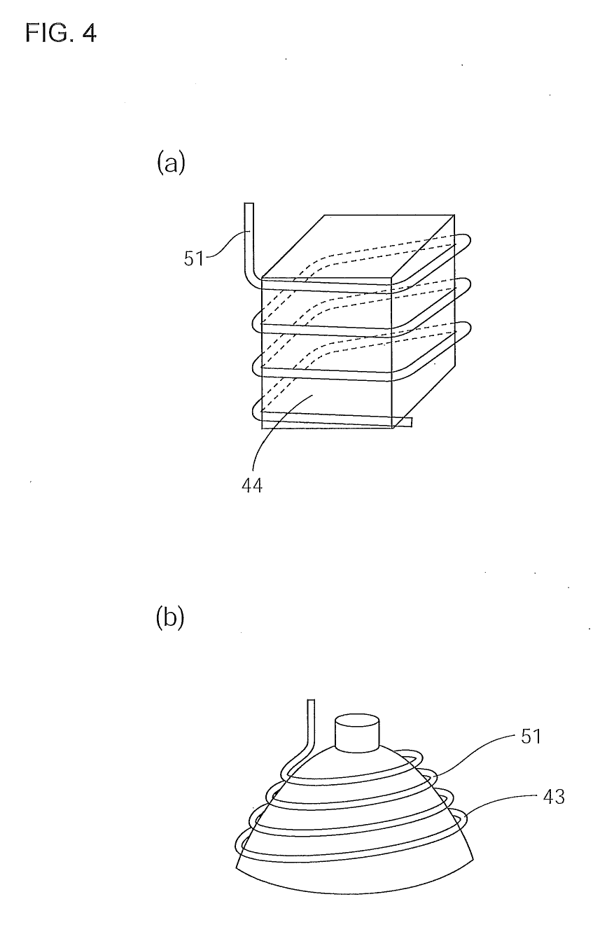

FIG. 4 is a descriptive view showing an example of the arrangement of the refrigerant circulating pipe in the cooling mechanism 50. In the example of FIG. 4(a), the refrigerant circulating pipe 51 is mounted so as to surround the external peripheral surface of the lens-barrel 44 of the heat lamp unit 40 in a helical shape. In the example of the FIG. 4(b), the refrigerant circulating pipe 51 is mounted in the shape of a truncated cone along the rear surface of the reflecting mirror 43 (lamp cover) of the heat lamp unit 40.

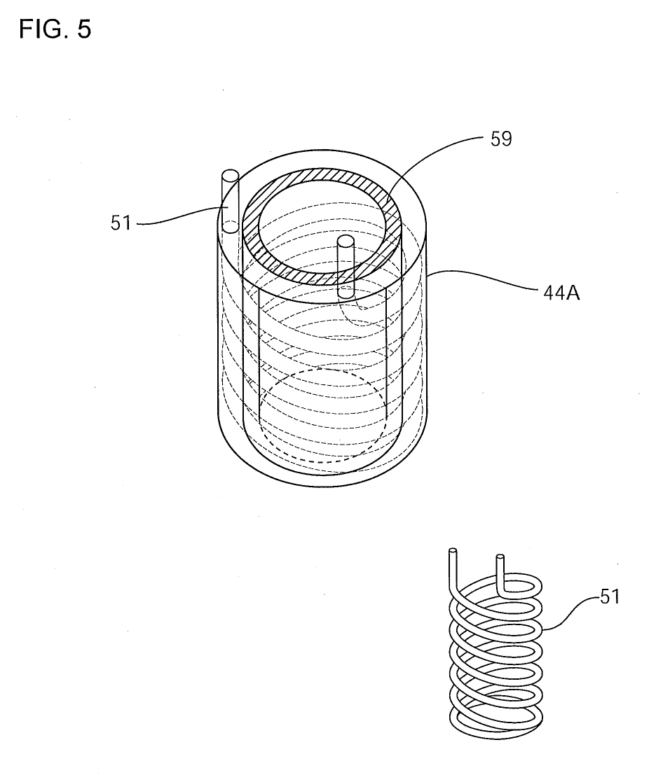

Next, the cooling mechanism 50 may be combined with insulating material so that the inkjet head 11 does not become heated. For example, the lens-barrel 44A of the heat lamp unit 40 may be cylindrical, and the refrigerant circulating pipe 51 may be disposed in a helical shape at a fixed pitch in the axial direction of the lens-barrel on the internal peripheral surface at equiangular intervals, as shown in FIG. 5. A cylindrical insulating material 59 is arranged inside the refrigerant circulating pipe 51 so as to cover the refrigerant circulating pipe 51 and the internal peripheral surface of the lens-barrel. In this manner, the inkjet head 11 can be prevented from heating using the effects of heat dissipation and insulation.

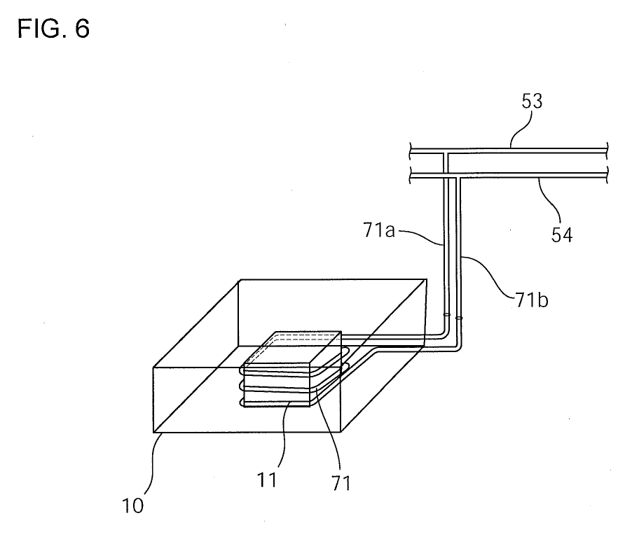

Next, the cooling mechanism 50 may be mounted on the heat lamp unit 40, and the cooling mechanism may be mounted on the inkjet head 11 or the head carriage 10 to thereby directly cool these components. For example, a head-side refrigerant circulating pipe 71 is arranged so as to surround the external periphery of the inkjet printer 1 mounted on the head carriage 10, as shown in FIG. 6, and flexible refrigerant circulating tubes 71a, 71b are connected to the two ends of the head-side refrigerant circulating pipe, respectively. The tubes are brought out to the exterior of the head carriage 10 and connected to the refrigerant circulating tubes 53, 54 so as to form a parallel state with the refrigerant circulating pipe 51. In accordance with this configuration, the inkjet head 11 can be reliably prevented from being brought into a heated state.

On the other hand, it is also possible to adopt a configuration in which a heat lamp unit 40 is disposed on both sides of the inkjet head 11.

### (Method for Controlling the Heater)

In the case that the materials of the recording media to be printed are different, the specific heat of each recording medium will be different and the irradiation temperature suitable for curing the ink droplets deposited on the recording media must be varied. The method for varying the irradiation temperature may be one in which the drive voltage and the drive current of the heating means, e.g., the heating lamp, are regulated. A light-shielding filter may be inserted into or removed from the irradiation path of the irradiating light to adjust the amount of irradiating light and to vary the irradiation temperature.

The switching control of the irradiation temperature can be implemented by providing a manual selection switch and operating the switch to switch between multiple steps. It is also possible to install an irradiation temperature control program in the printer driver so as to automatically control the irradiation temperature in accordance with the ambient temperature, the type of material of the selected recording medium, and other factors.

The heat produced by the heater is preferably regulated only when necessary. Specifically, heating of the inkjet head 11 can be suppressed and power consumption by the heater can be reduced by switching on the heater and heating the surface of the recording medium only when print is actually carried out by the inkjet head 11.

In the case that a halogen lamp or another discharge lamp is used as the heat lamp unit 40, the halogen lamp is preferably driven and controlled in the following manner. First, when the halogen lamp has been switched on, the lamp instantly lights up and the temperature is increased to a target value. A semi-lighted state can be formed by regulating the drive voltage of the halogen lamp in order to increase the speed of the temperature increase.

A switch is made to the full lighting state only when the inkjet head performs printing. The extinguished or semi-lighted state is maintained at other times. For example, such a state is maintained when the inkjet head is on standby in the home position or when the inkjet head is being cleaned. A thermistor and a thermocouple can be used and temperature management can be performed in the lamp drive control circuit so as to avoid an extreme increase in temperature. Also, an emergency shutdown circuit is provided for use during an abnormality, and the lamp can be forcibly switched off.

An irradiation temperature control circuit is preferably provided because the irradiation temperature must be modified depending on the recording medium.

1. An inkjet printer, comprising:
an inkjet head;
a platen for defining a print position for the inkjet head;
a heater for heating ink droplets discharged from the inkjet head and deposited on a recording medium on the platen;
a head carriage for supporting the inkjet head and the heater; and
a cooling mechanism for cooling the external peripheral surface portion excluding the heat-radiating aperture in the heater, the cooling mechanism having:
a refrigerant circulating pipe disposed in a state of contact with the constituent elements of the heater inside and/or outside the heater;
a refrigerant circulating pump disposed in a fixed position that does not interfere with the head carriage;
a flexible refrigerant circulating tube for placing the refrigerant circulating pipe and the refrigerant circulating pump in communication with each other; and
a cooling device for cooling the refrigerant that flows through the refrigerant circulating tube.

2. The inkjet printer according to claim 1, wherein
the heater is provided with a cylindrical casing in which one open end is the heat-radiating aperture, and
the refrigerant circulating pump is disposed in a state of contact with an external peripheral surface and/or an internal peripheral surface of the casing.

3. The inkjet printer according to claim 2, wherein the refrigerant circulating pipe is arranged in a helical shape along the external peripheral surface and/or the internal peripheral surface of the casing.

4. The inkjet printer according to claim 2, wherein an insulating material is arranged along the internal peripheral surface of the casing; and
the refrigerant circulating pipe is arranged between the internal peripheral surface and the insulating material.

5. The inkjet printer according to claim 1, wherein the heater has a halogen lamp or another discharge lamp, a reflecting mirror for reflecting light emitted from the discharge lamp toward the heat-radiating aperture, and a cylindrical lens-barrel that coaxially extends from an emission aperture of the reflecting mirror in an emission direction.

6. The inkjet printer according to claim 5, wherein the refrigerant circulating pipe is disposed in a state of contact with an external peripheral surface and/or internal peripheral surface of the lens-barrel.

7. The inkjet printer according to claim 6, wherein the refrigerant circulating pipe is disposed in a state of contact with an external peripheral surface of the reflecting mirror.

8. The inkjet printer according to claim 6, wherein the refrigerant circulating pipe is arranged in a helical shape.

9. The inkjet printer according to claim 1, wherein the cooling mechanism has a head-side refrigerant circulating pipe disposed in a state of contact with constituent elements of the head carriage and/or the inkjet head, and a refrigerant is circulated from the refrigerant circulating pump through the refrigerant circulating tube and the head-side refrigerant circulating pipe.

10. The inkjet printer according to claim 1, wherein the inkjet head prints using resin ink or another thermosetting ink.

11. The inkjet printer according to claim 7, wherein the refrigerant circulating pipe is arranged in a helical shape.
